(19) United States
(12) Patent Application Publication
(10) Pub. No.: US 2024/0073161 A1
(43) Pub. Date: Feb. 29, 2024

(54) MESSAGE PROCESSING METHOD, INFORMATION PROCESSING APPARATUS, AND PROGRAM

(71) Applicant: SoundHound AI IP, LLC, Santa Clara, CA (US)

(72) Inventors: Yuki Matsuda, Tokyo (JP); Keisuke Tsuchida, Tokyo (JP)

(73) Assignee: SoundHound AI IP, LLC., Santa Clara, CA (US)

(21) Appl. No.: 18/456,219

(22) Filed: Aug. 25, 2023

(30) Foreign Application Priority Data
Aug. 26, 2022 (JP) 2022-171568

(51) Int. Cl. H04L 51/04; H04L 51/02; H04L 51/216

(52) U.S. Cl. CPC H04L 51/04; H04L 51/02; H04L 51/216

(57) ABSTRACT

[Object] To provide a technique for more accurate interpretation of a message inputted by a user.

[Solving Means] An information processing server 300 obtains a first message from a user in a thread 001, has a context of the first message stored in a context database 500 in association with the thread 001, obtains a second message from the user in the thread 001, and provides the second message to a conversation server 400 together with the context of the first message.

### FIELD OF THE INVENTION

This application claims priority to Japan Patent Application No. 2022-171568 filed Aug. 26, 2022, which application is incorporated by reference herein in its entirety.

### FIELD OF THE INVENTION

The present disclosure relates to a message processing method.

### BACKGROUND

A technique to process a message from a user has conventionally variously been discussed. For example, NPL 1 (“Virtual assistant,” [online], Sep. 9, 2022, the Internet <URL: https://en.wikipedia.org/wiki/Virtual_assistant>) discloses a virtual assistant that provides various tasks or services in response to an input of a text message or a voice message from a user.

### CITATION LIST

### Non Patent Literature

NPL 1: “Virtual assistant,” [online], Sep. 9, 2022, the Internet <URL: https://en.wikipedia.org/wiki/Virtual_assistant>

### SUMMARY OF THE INVENTION

### Problem to be Solved by the Invention

In order to more accurately reflect a user's intention on a provided task or service in the technique described above, a technique for more accurate interpretation of a message from the user has been demanded.

The present disclosure was made in view of such circumstances, and an object thereof is to provide a technique for more accurate interpretation of a message inputted by a user.

### Means for Solving the Problem

According to one aspect of the present disclosure, a message processing method including obtaining, by an information processing apparatus, a first message from a first entity, storing, by the information processing apparatus, a context of the first message in a storage device in association with the first entity, obtaining, by the information processing apparatus, a second message from the first entity, and providing, by the information processing apparatus, the second message to an interpretation server that interprets a message, together with the context of the first message is provided.

### Effects of the Invention

According to the present disclosure, a context of a message in the past in a certain entity is provided to an interpretation server together with a message in connection with the entity. The interpretation server can thus interpret a message not including detailed contents, based on contents in the past in the entity to which the message belongs. Therefore, a message inputted by a user can more accurately be interpreted.

### BRIEF DESCRIPTION OF THE DRAWINGS

FIG. 1 is a diagram showing an exemplary configuration of a message processing system.

FIG. 2 is a diagram showing an exemplary hardware configuration of a user terminal 100.

FIG. 3 is a diagram showing an exemplary hardware configuration of a communication server 200.

FIG. 4 is a diagram showing an exemplary hardware configuration of an information processing server 300.

FIG. 5 is a diagram showing an exemplary hardware configuration of a conversation server 400.

FIG. 6 is a diagram showing an exemplary interaction in a message processing system 1.

FIG. 7 is a diagram showing another exemplary interaction in message processing system 1.

FIG. 8 is a diagram schematically showing a flow of information for the interactions in two threads shown in FIGS. 6 and 7.

FIG. 9 is a diagram schematically showing an example of information stored in a context database 500.

FIG. 10 is a diagram schematically showing another example of information stored in context database 500.

FIG. 11 is a diagram schematically showing yet another example of information stored in context database 500.

FIG. 12 is a diagram schematically showing yet another example of information stored in context database 500.

FIG. 13 is a diagram showing a flow of processing in each of information processing server 300 and conversation server 400.

FIG. 14 is a diagram showing another exemplary configuration of a message processing system.

FIG. 15 is a diagram showing an exemplary interaction in a message processing system 2.

FIG. 16 is a diagram schematically showing a flow of information in generation of order information shown in FIG. 15.

FIG. 17 is a diagram schematically showing a flow of information in generation of the order information shown in FIG. 15.

FIG. 18 is a diagram showing one example of information stored in context database 500.

FIG. 19 is a diagram showing another example of information stored in context database 500.

FIG. 20 is a diagram showing yet another example of information stored in context database 500.

FIG. 21 is a diagram showing yet another example of information stored in context database 500.

FIG. 22 is a diagram showing yet another example of information stored in context database 500.

FIG. 23 is a diagram showing yet another example of information stored in context database 500.

FIG. 24 is a diagram showing another exemplary interaction in message processing system 2.

FIG. 25 is a diagram schematically showing a flow of information in generation of order information shown in FIG. 24.

FIG. 26 is a diagram showing an example of information stored in context database 500.

FIG. 27 is a diagram showing yet another example of information stored in context database 500.

FIG. 28 is a diagram showing yet another example of information stored in context database 500.

### DETAILED DESCRIPTION

An embodiment of a message processing system will be described below with reference to the drawings. The same components and constituent elements in the description below have the same reference characters allotted and their labels and functions are also the same. Therefore, description thereof will not be repeated.

### First Embodiment

[1. Configuration of Message Processing System]

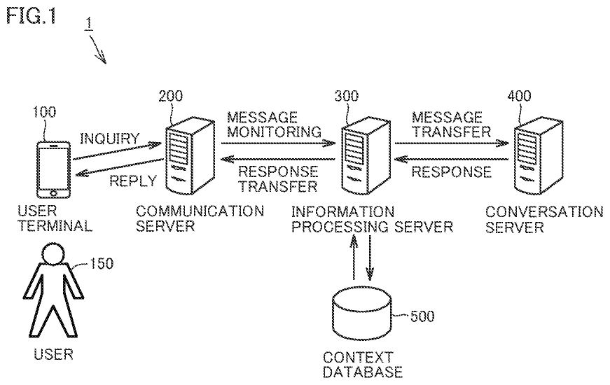

FIG. 1 is a diagram showing an exemplary configuration of a message processing system. As shown in FIG. 1, a message processing system 1 includes a user terminal 100, a communication server 200, an information processing server 300, a conversation server 400, and a context database 500.

In one implementation, user terminal 100 is implemented by a computer (a smartphone, a tablet terminal, a personal computer, or the like) operated by a user.

Communication server 200 is a server that provides a chat service such as Slack®.

Information processing server 300 is a server that provides a chatbot in the chat service. Information processing server 300 represents an exemplary information processing apparatus in message processing system 1.

Conversation server 400 performs various types of processing including interpretation of a message for having information processing server 300 function as a chatbot. Conversation server 400 is an exemplary interpretation server in message processing system 1.

Context database 500 manages a context of a message inputted by a user in message processing system 1. In one implementation, the context may mean an intention and/or a target of a message. In addition to or instead of such meaning, the context may mean additional information such as a location and/or time annexed to a message or a history of such additional information.

[2. Overview of Function of Message Processing System]

Overview of a function of message processing system 1 will be described with reference to FIG. 1.

An application program for using the aforementioned chat service has been installed in user terminal 100. A user 150 inputs a message (an inquiry) into one thread of the chat service with the use of user terminal 100. User terminal 100 inputs the inputted message to the chat service. A message on the chat service is managed in communication server 200. In user terminal 100, input of a message to a message service may be done on a dedicated application program or on a dedicated site accessed through a browser.

Information processing server 300 monitors an input of a message from the user in the chat service. As a message from the user is inputted to the chat service, information processing server 300 obtains the message from communication server 200 and transfers the message to conversation server 400.

Conversation server 400 interprets the message from the user, generates a response to the message, and transmits the generated response to information processing server 300. Information processing server 300 transfers the response transmitted from conversation server 400 to communication server 200. Communication server 200 provides the response transferred from information processing server 300 to user terminal 100. At this time, the response is provided as a reply to the message (inquiry) inputted from user 150 in the thread of the chat service.

Conversation server 400 transmits the context generated in interpretation of the message to information processing server 300 together with the response. Information processing server 300 has the context transmitted from conversation server 400 stored in context database 500 in association with the thread.

Thereafter, as information processing server 300 obtains the message in the thread, it searches context database 500 for the context stored in association with the thread. Then, information processing server 300 transmits the message obtained in the thread to conversation server 400 together with the context obtained as a search result. Conversation server 400 can thus use the context generated for a message in the past in the thread for interpretation of the message in the thread.

[3. Hardware Configuration]

(User Terminal 100)

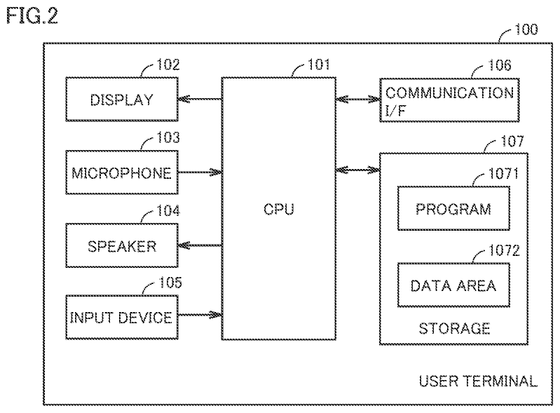

FIG. 2 is a diagram showing an exemplary hardware configuration of user terminal 100. User terminal 100 includes a central processing unit (CPU) 101, a display 102, a microphone 103, a speaker 104, an input device 105, a communication interface (UF) 106, and a storage 107. Storage 107 is implemented by a memory device where data is stored in a non-volatile manner. Storage 107 includes a program area 1071 where various programs are stored and a data area 1072 where various types of data are stored.

CPU 101 includes at least one processor and performs various types of computation by executing a program stored in storage 107 or an external storage device.

Display 102 shows a screen indicated by CPU 101. Microphone 103 inputs inputted voice and sound into CPU 101. Speaker 104 outputs voice and sound indicated by CPU 101. Input device 105 is implemented, for example, by a physical key and/or a touch sensor, and accepts an input of information from the user. Communication OF 106 is implemented, for example, by a network card, and allows user terminal 100 to communicate with another device (for example, communication server 200) within interaction system 1.

(Communication Server 200)

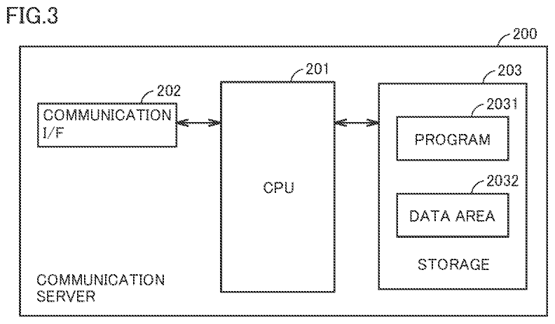

FIG. 3 is a diagram showing an exemplary hardware configuration of communication server 200. Communication server 200 includes a CPU 201, a communication OF 202, and a storage 203. Storage 203 is implemented by a memory device where data is stored in a non-volatile manner. Storage 203 includes a program area 2031 where various programs are stored and a data area 2032 where various types of data are stored.

CPU 201 includes at least one processor and performs various types of computation by executing a program stored in storage 203 or an external storage device. Communication OF 202 is implemented, for example, by a network card, and allows communication server 200 to communicate with another device (user terminal 100, information processing server 300, or the like) within message processing system 1.

(Information Processing Server 300)

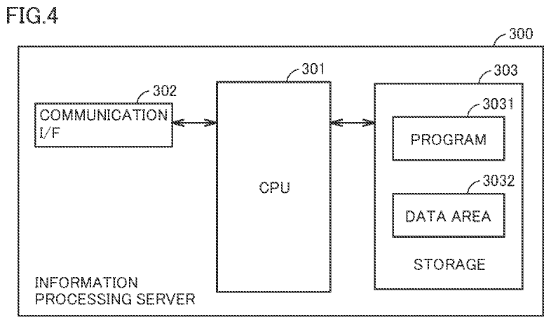

FIG. 4 is a diagram showing an exemplary hardware configuration of information processing server 300. Information processing server 300 includes a CPU 301, a communication OF 302, and a storage 303. Storage 303 is implemented by a memory device where data is stored in a non-volatile manner. Storage 303 includes a program area 3031 where various programs are stored and a data area 3032 where various types of data are stored.

CPU 301 includes at least one processor and performs various types of computation by executing a program stored in storage 303 or an external storage device. Communication OF 302 is implemented, for example, by a network card, and allows information processing server 300 to communicate with another device (information processing server 300, conversation server 400, context database 500, or the like) within message processing system 1.

(Conversation Server 400)

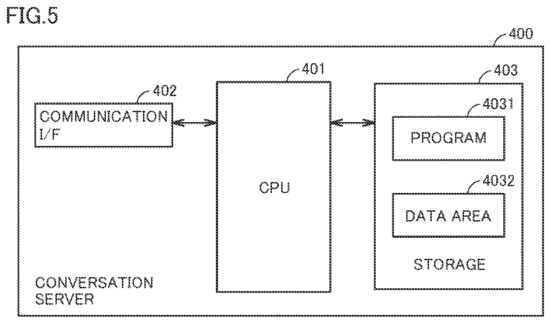

FIG. 5 is a diagram showing an exemplary hardware configuration of conversation server 400. Conversation server 400 includes a CPU 401, a communication OF 402, and a storage 403. Storage 403 is implemented by a memory device where data is stored in a non-volatile manner. Storage 403 includes a program area 4031 where various programs are stored and a data area 4032 where various types of data are stored.

CPU 401 includes at least one processor and performs various types of computation by executing a program stored in storage 403 or an external storage device. Communication OF 402 is implemented, for example, by a network card, and allows conversation server 400 to communicate with another device (for example, information processing server 300) within message processing system 1.

(Context Database 500)

Context database 500 is implemented by a given computer, and various types of data are stored therein. Context database 500 may be implemented as a part of another element (for example, information processing server 300) within message processing system 1 or as a hardware resource separate from another element within message processing system 1.

[4. Specific Example of Interaction in Message Processing System]

In message processing system 1, a context of a message is managed for each thread. In this sense, in message processing system 1, each thread implements an exemplary entity. Management of a context in connection with each thread will be described below together with specific examples of interactions in two threads.

(Exemplary Interaction)

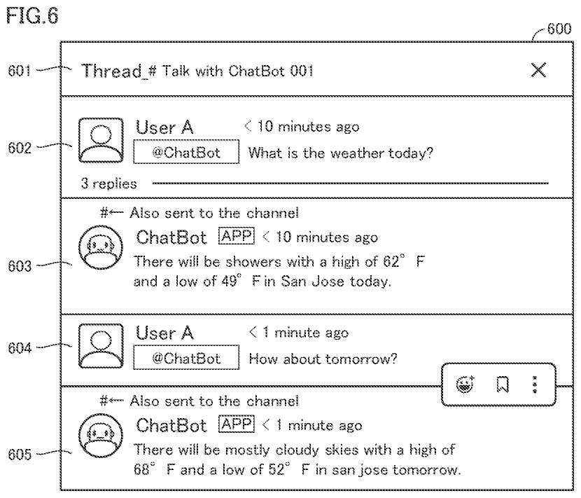

FIG. 6 is a diagram showing an exemplary interaction in message processing system 1.

FIG. 6 shows a screen 600 showing an interaction between a user A and a chatbot. Screen 600 shows an interaction in a certain thread in a chat service. On screen 600, in a field 601, a character string “Thread_#talk with chatbot 001” representing information on a thread is shown.

Each of fields 602 to 605 shows a message in the thread. More specifically, field 602 shows a message “WHAT IS THE WEATHER TODAY?” from user A. Field 603 shows a message “THERE WILL BE SHOWERS WITH A HIGH OF 62° F. AND A LOW OF 49° F. IN SAN JOSE TODAY” from the chatbot. Field 604 shows a message “HOW ABOUT TOMORROW?” from user A. Field 605 shows a message “THERE WILL BE MOSTLY CLOUDY SKIES WITH A HIGH OF 68° F. AND A LOW OF 52° F. IN SAN JOSE TOMORROW” from the chatbot.

(Another Exemplary Interaction)

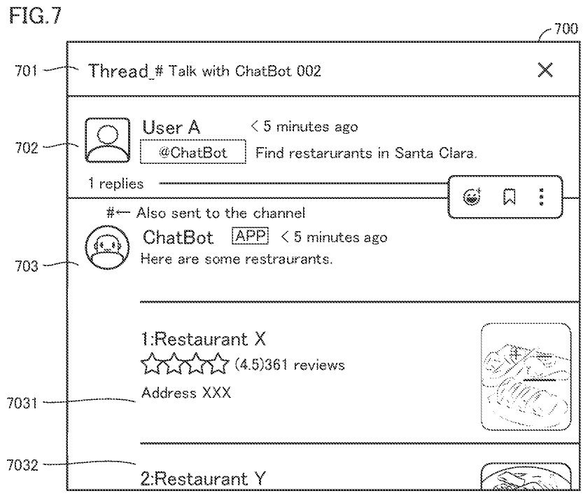

FIG. 7 is a diagram showing another exemplary interaction in message processing system 1.

FIG. 7 shows a screen 700 showing an interaction between user A and the chatbot. Screen 700 shows a thread in the chat service, and shows an interaction in a thread different from that in the example shown in FIG. 6. On screen 700, in a field 701, a character string “Thread_#talk with chatbot 002” representing information on a thread is shown.

Each of fields 702 to 703 shows a message in the thread. More specifically, field 702 shows a message “FIND RESTAURANTS IN SANTA CLARA” from user A. Field 703 shows a message “HERE ARE SOME RESTAURANTS” from the chatbot. Field 703 includes two fields 7031 and 7032. Field 7031 shows information on “Restaurant X” which is a first result of search for a restaurant. Field 7032 shows information on “Restaurant Y” which is a second result of a search for a restaurant.

(Flow of Information)

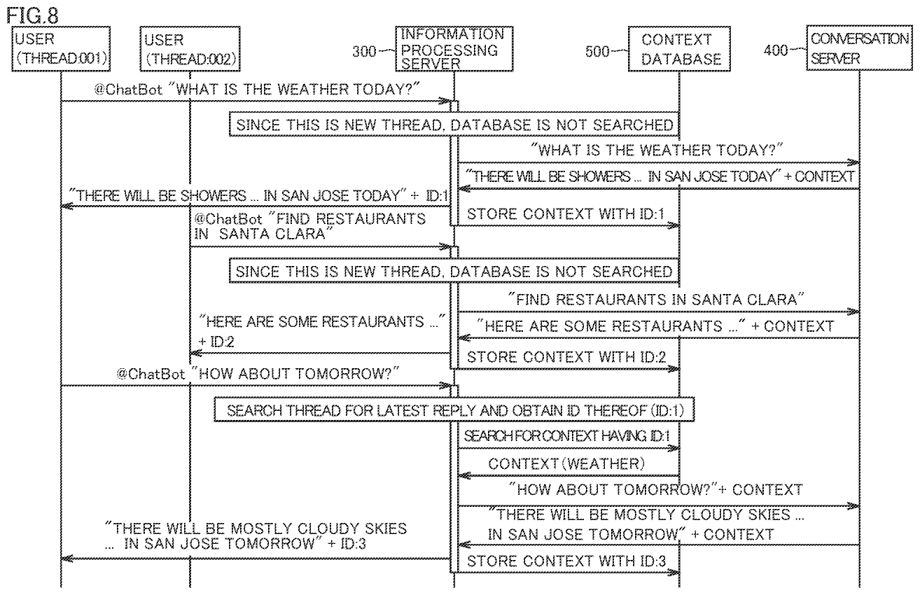

FIG. 8 is a diagram schematically showing a flow of information for the interactions in the two threads shown in FIGS. 6 and 7.

In the example in FIG. 8, the thread in FIG. 6 is shown as a “thread 001” and the thread in FIG. 7 is shown as a “thread 002.” A “user (thread 001)” represents an interaction with user A that occurs as the thread 001 in communication server 200. A “user (thread 002)” represents an interaction with user A that occurs as the thread 002 in communication server 200. “@ChatBot” represents that a message in the thread is destined to the chatbot.

Information processing server 300 monitors a message obtained by communication server 200 from the user. As communication server 200 obtains a message “WHAT IS THE WEATHER TODAY?” (field 602 in FIG. 6) in the thread 001, information processing server 300 obtains the message. This message is the first message in the thread 001. In other words, at this time point, the thread 001 is a new thread for information processing server 300. Therefore, information processing server 300 transmits this message to conversation server 400 without searching context database 500 for a context.

In the chat service, a message may be inputted as voice and sound or text. In interpretation of a message, conversation server 400 may process text corresponding to the message. When a voice message is inputted, the voice may be converted to text by any of communication server 200, information processing server 300, and the interpretation server. In the chat service, a voice message, a text message, or both of them may be outputted.

Conversation server 400 processes the message “WHAT IS THE WEATHER TODAY?” from user A to generate a response thereto. In one implementation, processing of the message includes interpretation of the message, identification of a command based on the interpretation, and execution of the command.

Interpretation of a message includes natural language processing of the message. Conversation server 400 may identify the context of the message in interpretation of the message. In one implementation, for identification of the context, conversation server 400 identifies grammar in natural language processing to which the message conforms. Then, conversation server 400 identifies the context associated with the identified grammar as the context of the message. For example, a context “weather” is identified from the message “WHAT IS THE WEATHER TODAY?”

Conversation server 400 may identify a command corresponding to the message based on the context. In one implementation, a command “provide weather forecast” may be associated with the context “weather”. Conversation server 400 may identify the command “provide weather forecast” based on the context “weather”.

Conversation server 400 may use information in connection with user A in identification of the command. Exemplary information in connection with user A include information representing a location San Jose. Conversation server 400 may update the identified command to the command “provide weather forecast in San Jose” with the information “San Jose” relating to user A while the command “provide weather forecast” is identified.

The information in connection with user A may be registered in advance in conversation server 400. As information processing server 300 transmits the message to conversation server 400 together with information identifying a target user (user A), conversation server 400 identifies information in connection with the target user (user A) and processes the message with the information.

The information in connection with user A may be transmitted from information processing server 300 to conversation server 400. In one implementation, communication server 200 may obtain position information from user terminal 100 and information processing server 300 obtains the position information from communication server 200 together with the message.

In execution of a command, conversation server 400 may use an external server (for example, an application programming interface (API) server) as necessary. In one implementation, for executing the command “provide weather forecast of San Jose,” conversation server 400 accesses the API server for weather forecast and generates a response from information obtained from the API server.

As conversation server 400 generates a response “THERE WILL BE SHOWERS WITH A HIGH OF 62° F. AND A LOW OF 49° F. IN SAN JOSE TODAY,” it transmits the response to information processing server 300. Conversation server 400 transmits the context (weather) used for generation of the response to information processing server 300.

Information processing server 300 transmits the response transmitted from conversation server 400 to communication server 200. In response, communication server 200 outputs the response (field 603 in FIG. 6) as a reply to the message from user A. User A thus obtains the response as the reply to the message “WHAT IS THE WEATHER TODAY?” in the thread 001.

Information processing server 300 provides an ID to the response. More specifically, in the example in FIG. 8, an ID “1” is given to the response “THERE WILL BE SHOWERS WITH A HIGH OF 62° F. AND A LOW OF 49° F. IN SAN JOSE TODAY.”

Information processing server 300 further has the context obtained for the message from user A on which the response provided with the ID=1 is based stored in context database 500 together with information that identifies the thread and the ID. The context “weather” is thus stored in context database 500 in association with the thread 001 and the ID=1.

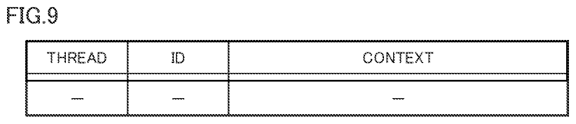

FIG. 9 is a diagram schematically showing an example of information stored in context database 500. As shown in FIG. 9, in context database 500, information is stored to include three types of items (the thread, the ID, and the context).

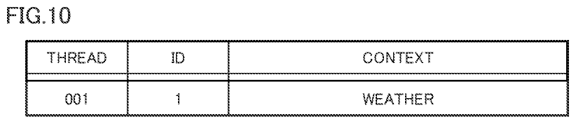

FIG. 10 is a diagram schematically showing another example of information stored in context database 500. As information processing server 300 has the context stored as above, as shown in FIG. 10, the context “weather” associated with the thread 001 and the ID=1 is stored in context database 500.

Referring back to FIG. 8, as communication server 200 obtains a message “FIND RESTAURANTS IN SANTA CLARA” (field 702 in FIG. 7) in the thread 002, information processing server 300 obtains the message. This message is the first message in the thread 002. In other words, at this time point, the thread 002 is a new thread for information processing server 300. Therefore, information processing server 300 transmits this message to conversation server 400 without searching context database 500 for a context.

As conversation server 400 processes the message “FIND RESTAURANTS IN SANTA CLARA,” it generates a response “HERE ARE SOME RESTAURANTS . . . ” to the message. Then, conversation server 400 transmits the response to information processing server 300 together with the context (restaurant) of the message.

Information processing server 300 provides an ID to the response “HERE ARE SOME RESTAURANTS . . . ” This ID is shown as “2” in the example in FIG. 8. Information processing server 300 transmits the response transmitted from conversation server 400 to communication server 200 together with the provided ID. Communication server 200 thus outputs the response (field 703 in FIG. 7) transmitted from information processing server 300 as the reply to the message. User A thus obtains the response as a reply to the message “FIND RESTAURANTS IN SANTA CLARA” in the thread 002.

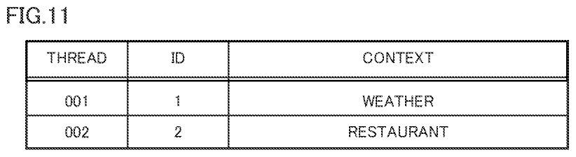

Information processing server 300 further has the context transmitted from conversation server 400 stored in context database 500 together with the provided ID. The context (restaurant) is thus stored in context database 500 in association with the thread 002 and the ID=2. FIG. 11 is a diagram schematically showing yet another example of information stored in context database 500. As shown in FIG. 11, the context “restaurant” is further stored in context database 500 in association with the thread 002 and the ID=2.

Referring back to FIG. 8, when communication server 200 obtains a message “HOW ABOUT TOMORROW?” (field 604 in FIG. 6) in the thread 001, information processing server 300 obtains the message. Information processing server 300 has already obtained messages in the thread 001. Therefore, information processing server 300 searches context database 500 for the context associated with the thread 001. More specifically, information processing server 300 searches for the context provided with the latest ID among contexts associated with the thread 001. As shown in FIG. 11, the context “weather” is stored in context database 500 in association with the thread 001. Therefore, information processing server 300 obtains the context “weather” as a result of the search.

Then, information processing server 300 transmits the message “HOW ABOUT TOMORROW?” to conversation server 400 together with the context “weather” which is the result of search.

As conversation server 400 interprets the message “HOW ABOUT TOMORROW?” with the context “weather”, it generates a response. Information processing server 300 may transmit information that identifies user A to conversation server 400 together with the conversation. Conversation server 400 may identify information in connection with user A based on the information that identifies user A and use the information in connection with user A for interpretation of the message from user A.

Conversation server 400 uses the context “weather” transmitted from information processing server 300 for interpretation of the message from user A. Thus, even when the message from user A does not include information representing “weather” or “weather” is not registered in advance as the information relating to user A, conversation server 400 can interpret the message with the use of the context “weather”.

Conversation server 400 generates a response “THERE WILL BE MOSTLY CLOUDY SKIES WITH A HIGH OF 68° F. AND A LOW OF 52° F. IN SAN JOSE TOMORROW” to the message “HOW ABOUT TOMORROW?” Then, conversation server 400 transmits this response to information processing server 300 together with the context used in interpretation of the message “HOW ABOUT TOMORROW?” The context used in interpretation of the message “HOW ABOUT TOMORROW?” may be a context newly identified in interpretation of the message “HOW ABOUT TOMORROW?” or a context received from information processing server 300 together with the message “HOW ABOUT TOMORROW?”, that is, the context identified in interpretation of a message preceding the message “HOW ABOUT TOMORROW?”

Information processing server 300 provides a new ID (3) to the response transmitted from conversation server 400 and transmits the response to communication server 200 together with the ID=3. Communication server 200 thus outputs the response (field 605 in FIG. 6) transmitted from information processing server 300 as a reply to the message. User A thus obtains the response as the reply to the message “HOW ABOUT TOMORROW?” in the thread 001.

Information processing server 300 further has the context transmitted from conversation server 400 stored in context database 500 together with information that identifies the thread and the ID. This context is thus stored in context database 500 in association with the thread 001 and the ID=3.

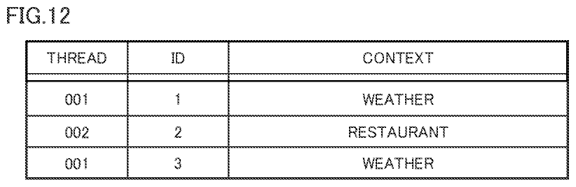

FIG. 12 is a diagram schematically showing yet another example of information stored in context database 500. As shown in FIG. 12, the context “weather” is further stored in context database 500 in association with the thread 001 and the ID=3.

As described above with reference to FIGS. 6 to 12, information processing server 300 manages the context for each thread in context database 500. Thus, in the thread 001, a context generated for a certain message is used for interpretation of a subsequent message. In the thread 002, a context generated for the thread 001 but not generated for the thread 002 is not used for interpretation of a message in the thread 002. As described with reference to FIG. 8, for example, the context “weather” in the thread 001 is not used for interpretation of a message in the thread 002.

The context used for interpretation of the message “FIND RESTAURANTS IN SANTA CLARA” in the thread 002 is stored in context database 500. When another message is inputted in the thread 002, information processing server 300 transmits the context to conversation server 400 together with that another message. Conversation server 400 uses the context transmitted from information processing server 300 for interpretation of that another message. In other words, when a second message is inputted after input of the first message in the thread 001, the context used for interpretation of the first message is used for interpretation of the second message. In the thread 002, when a fourth message is inputted after input of a third message, a context used for interpretation of the third message is used for interpretation of the fourth message.

[5. Flow of Processing]

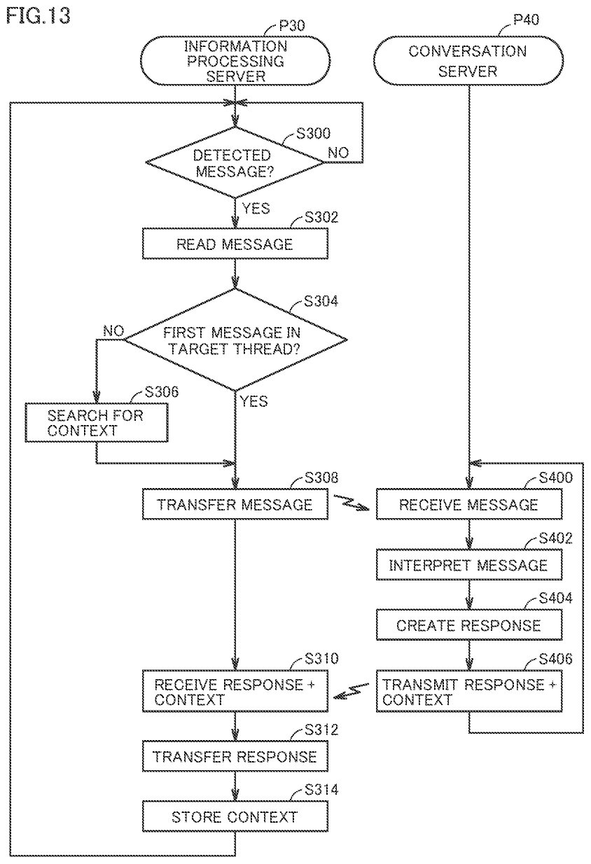

FIG. 13 is a diagram showing a flow of processing in each of information processing server 300 and conversation server 400. Processing P30 represents processing on a side of information processing server 300. In one implementation, as CPU 301 executes a given program, processing on the side of information processing server 300 is performed. Processing P40 represents processing on a side of conversation server 400. In one implementation, as CPU 401 executes a given program, processing on the side of conversation server 400 is performed.

In step S300, information processing server 300 determines whether or not it has detected a message destined to a chatbot in a chat service. Information processing server 300 repeats control in step S300 until it detects a message (NO in step S300), and when it detects a message (YES in step S300), it has control proceed to step S302.

In step S302, information processing server 300 reads the detected message.

In step S304, information processing server 300 determines whether or not the detected message is the first message in a target thread. The target thread is a thread to which the detected message belongs. When the detected message is the first message in the target thread (YES in step S304), information processing server 300 has control proceed to step S308, and when the detected message is not the first message in the target thread (NO in step S304), it has control proceed to step S306.

In step S306, information processing server 300 searches context database 500 for a context associated with the target thread. At this time, all contexts associated with the target thread or only the latest context may be searched for. In an example where each context is associated with an ID in context database 500, determination as to being the “latest” may be made based on the ID associated with each context.

In step S308, information processing server 300 transfers the message read from communication server 200 in step S302 to conversation server 400. At this time, when information processing server 300 has obtained a result of search for the context in step S306, it further transmits the result of search (context) to conversation server 400.

In step S400, conversation server 400 receives the message transmitted from information processing server 300. At this time, when the context has been transmitted from information processing server 300, conversation server 400 further receives the context.

In step S402, conversation server 400 interprets the message received in step S400. When conversation server 400 has received the context in step S400, conversation server 400 may use the context in interpretation.

In step S404, conversation server 400 generates a response to the message received in step S400.

In step S406, conversation server 400 transmits the response generated in step S404 to information processing server 300 together with the context. The context transmitted in step S406 includes the context of the message received in step S400. The context of the message may be a context newly identified in interpretation of the message or a context transmitted from information processing server 300 together with the message.

In step S310, information processing server 300 receives the response and the context from conversation server 400.

In step S312, information processing server 300 transfers the response received in step S310 to communication server 200.

In step S314, information processing server 300 has the context received in step S310 stored in context database 500 in association with the target thread. Information processing server 300 may provide a time stamp to the response in step S310, and may have the context stored in context database 500 further in association with the time stamp in step S314. Thereafter, information processing server 300 has control return to step S300.

According to the flow of processing described above with reference to FIG. 13, information processing server 300 transmits the message obtained in a certain thread in the chat service to conversation server 400 together with the context associated with the thread. Conversation server 400 can thus use the context identified in the past in the thread for interpretation of the message obtained in the thread. Therefore, even when a certain message does not include information representing an intention and/or a target in the chat service, so long as information representing the intention and/or the target is included in messages in the past in the thread including the message, a response including contents in conformity with the intention and/or the target can be provided as the reply.

In the flow of processing described with reference to FIG. 13, the time stamp is used for identifying recency of each of a plurality of contexts stored in association with each thread. The ID described with reference to FIGS. 8 to 12, on the other hand, defines an order of storage of each context in context database 500 to thereby define recency of each context. Therefore, each of the ID in FIGS. 8 to 12 and the time stamp in FIG. 13 is an exemplary element that defines recency of each context. Recency of the context may be synonymous to message recency of a message from which the context is generated. For example, when the context “weather” is generated in interpretation of the message “WHAT IS THE WEATHER TODAY?”, recency of the context “weather” may represent recency of the message “WHAT IS THE WEATHER TODAY?”

### Second Embodiment

[1. Configuration of Message Processing System]

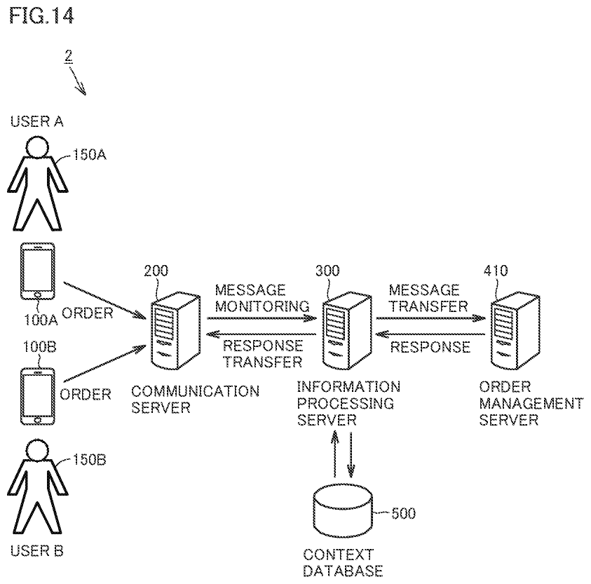

FIG. 14 is a diagram showing another exemplary configuration of a message processing system. As compared with FIG. 1, FIG. 14 shows a user terminal 100A operated by a user 150A and a user terminal 100B operated by a user 150B instead of user terminal 100. In addition, an order management server 410 is shown instead of conversation server 400. Order management server 410 generates order information on an order from a user by interpreting a message from the user. In other words, order management server 410 represents an exemplary interpretation server.

Each of user terminals 100A and 100B may be similar in hardware configuration to user terminal 100. Order management server 410 may be similar in hardware configuration to conversation server 400.

In a message processing system 2 shown in FIG. 14, communication server 200 accepts an order of goods in a chat service. In the chat service, user terminal 100A and user terminal 100B each input a message into a single thread.

[2. First Specific Example of Generation of Order Information]

(Interaction)

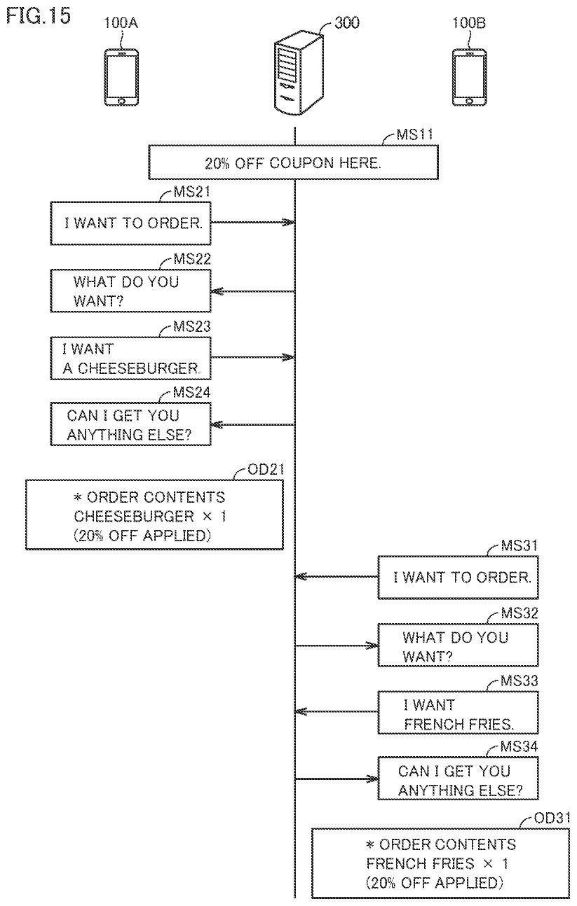

FIG. 15 is a diagram showing an exemplary interaction in message processing system 2. In the example in FIG. 15, user 150A and user 150B each input a message into a certain thread in the chat service. In message processing system 2, as the message from each of user 150A and user 150B is interpreted with a context common to the thread, order information of each of user 150A and user 150B is generated. The order information may be information for an order in a restaurant or an apparel store or an order in a delivery service. Generation of order information will more specifically be described below.

Referring to FIG. 15, a chatbot (information processing server 300) outputs a message “20% OFF HERE” as a message MS11. In one implementation, this message is generated by order management server 410 and transmitted to communication server 200 through information processing server 300. Communication server 200 outputs the message transmitted from order management server 410 to the chat service as a message from the chatbot.

In response, user terminal 100A (user 150A) inputs to the chat service, a message “I WANT TO ORDER” as shown with a message MS21.

In response, the chatbot outputs a message “WHAT DO YOU WANT?” as shown with a message MS22.

In response, user terminal 100A inputs a message “I WANT A CHEESEBURGER” to the chat service as shown with a message MS23.

In response, the chatbot outputs order information generated based on message MS23 together with a message “CAN I GET YOU ANYTHING ELSE?” as shown with a message MS24. The order information includes “CHEESEBURGER×1 (20% OFF APPLIED)” as shown with a screen OD21. This order information represents one cheese burger and application of 20% discount to one cheese burger. Application of 20% off is based on the context in the message in the past in this thread.

More specifically, in this thread, message MS11 includes “20% OFF” and “HERE”. The context of message MS11 thus includes “20% OFF APPLIED.” Then, message MS23 is interpreted with the context “20% OFF APPLIED.” Then, the order information is generated to represent application of 20% off to one cheese burger based on “CHEESE BURGER” and “A” included in message MS23 and the context “SERVICE: 20% OFF APPLIED.”

User terminal 100B (user 150B) inputs a message “I WANT TO ORDER” to the chat service as shown with a message MS31.

In response, the chatbot outputs a message “WHAT DO YOU WANT?” as shown with a message MS32.

In response, user terminal 100B inputs a message “I WANT FRENCH FRIES” to the chat service as shown with a message MS33.

In response, the chatbot outputs order information generated based on message MS33 together with a message “CAN I GET YOU ANYTHING ELSE?” as shown with a message MS34. The order information is “FRENCH FRIES×1 (20% OFF APPLIED)” as shown with a screen OD31. This order information represents french fries and application of 20% off to the french fries. Application of 20% off is based on the context of the message in the past in this thread as described above for screen OD21.

(Flow of Information)

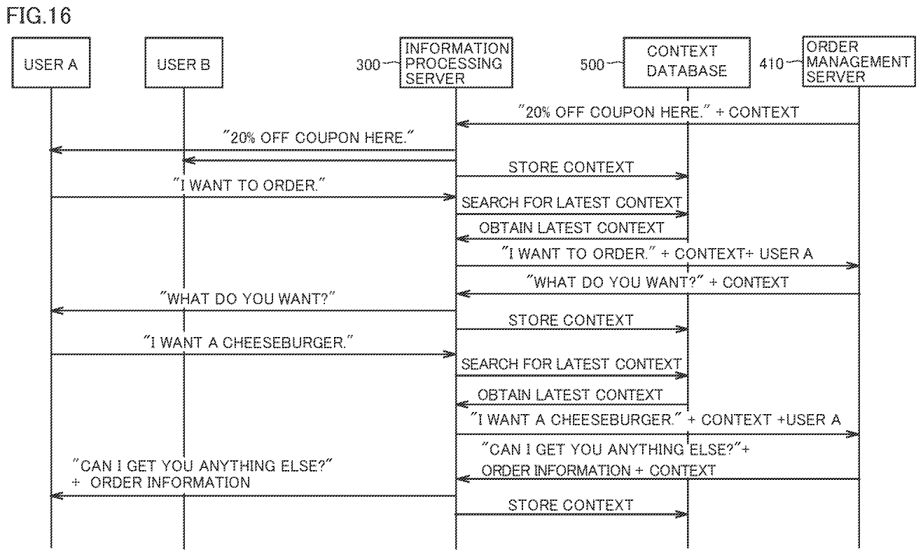

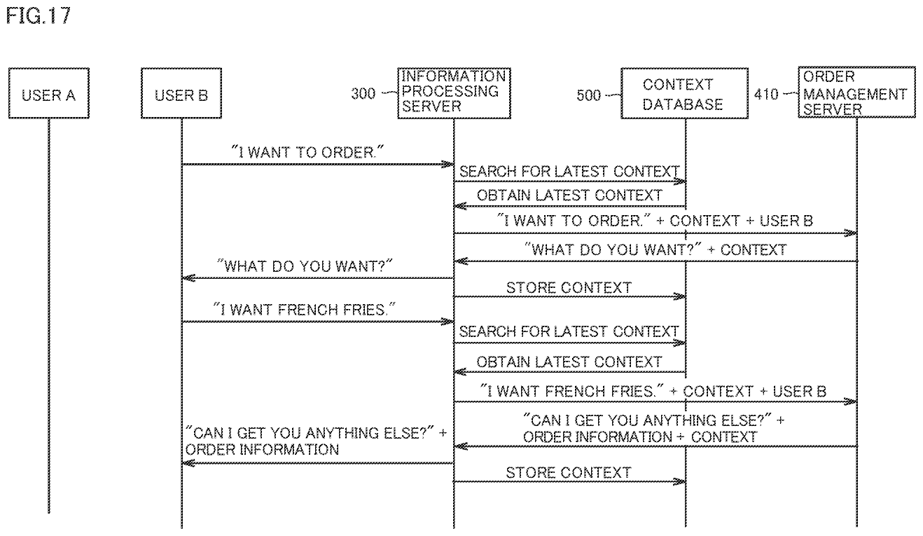

FIGS. 16 and 17 are diagrams schematically showing a flow of information in generation of order information shown in FIG. 15.

FIG. 16 mainly shows a conversation between the chat service and user 150A (which will also be referred to as “user A” below) in FIG. 15. Referring to FIG. 16, order management server 410 transmits the message “20% OFF HERE” and the context of this message to information processing server 300. Information processing server 300 transmits the message from order management server 410 to communication server 200 as the message from the chatbot. Communication server 200 outputs this message in the chat service.

Information processing server 300 has the context stored in context database 500.

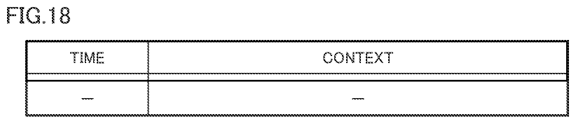

FIG. 18 is a diagram showing one example of information stored in context database 500. The context is stored in context database 500 in association with time. In the second embodiment, time stored in association with each context is an exemplary element that defines recency of each context.

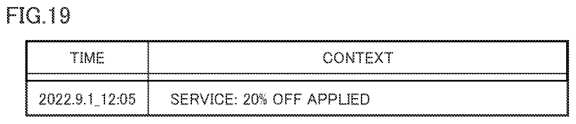

Order management server 410 generates “SERVICE: 20% OFF APPLIED” as the context of the message “20% OFF HERE.” FIG. 19 is a diagram showing another example of information stored in context database 500. In the example in FIG. 19, the context “SERVICE: 20% OFF APPLIED” is stored together with time (12:05 on Sep. 1, 2022) at which the context is stored.

Referring back to FIG. 16, in response to the message from the chatbot, user terminal 100A outputs the message “I WANT TO ORDER” to the chat service. As information processing server 300 obtains this message, it searches context database 500 for the context associated with the thread shown in FIG. 16. Then, information processing server 300 transmits the message from user terminal 100A, the context obtained as a result of search, and information that identifies the user (user A) of user terminal 100A to order management server 410.

Order management server 410 interprets the message transmitted from information processing server 300 and generates a response “WHAT DO YOU WANT?” to the message. The context transmitted from information processing server 300 can be used for interpretation.

Order management server 410 transmits the generated response to information processing server 300 together with the context of the message. The context of the message includes the context transmitted from information processing server 300 together with the message and/or the context generated in interpretation of the message.

Information processing server 300 transmits the response from order management server 410 to communication server 200. Communication server 200 outputs the response transmitted from information processing server 300 as a reply to user 150A.

Information processing server 300 further has the context transmitted from order management server 410 stored in context database 500.

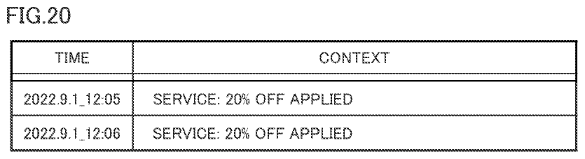

FIG. 20 is a diagram showing yet another example of information stored in context database 500. In FIG. 19, only the context at 12:05 on Sep. 1, 2022 is stored, whereas in FIG. 20, a context at 12:06 on Sep. 1, 2022 is further stored.

Referring back to FIG. 16, in response to the message from the chatbot, user terminal 100A outputs a message “I WANT A CHEESEBURGER” to the chat service. As information processing server 300 obtains this message, it searches context database 500 for a context associated with the thread shown in FIG. 16. In an example where a plurality of contexts are associated with the thread, information processing server 300 may search for only the latest context. Then, information processing server 300 transmits the message from user terminal 100A, the context obtained as a result of search, and the information that identifies the user (user A) of user terminal 100A to order management server 410.

Order management server 410 interprets the message transmitted from information processing server 300 to generate a response “CAN I GET YOU ANYTHING ELSE?” to the message and order information. The context transmitted from information processing server 300 can be used for interpretation. The order information is generated as the result of interpretation of the message and includes, for example, contents shown in screen OD21 in FIG. 15.

Order management server 410 transmits the generated response “CAN I GET YOU ANYTHING ELSE?” and the order information and the context of the message “I WANT A CHEESEBURGER” received from information processing server 300 to information processing server 300. The context of the message “I WANT A CHEESEBURGER” includes the context transmitted from information processing server 300 together with the message and/or the context generated in interpretation of the message. When the context “ITEM: CHEESE BURGER” and “USER: USER A” is generated in interpretation of the message “I WANT A CHEESEBURGER,” the context of the message may include “SERVICE: 20% OFF APPLIED,” “ITEM: CHEESE BURGER,” and “USER: USER A.”

Information processing server 300 transmits the response and the order information transmitted from order management server 410 to communication server 200, and communication server 200 outputs the response and the order information to the chat service. Information processing server 300 has the context transmitted from order management server 410 stored in context database 500.

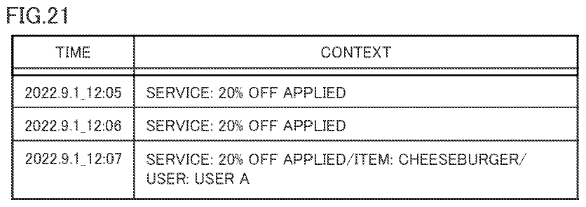

FIG. 21 is a diagram showing yet another example of information stored in context database 500. In FIG. 21, as compared with FIG. 20, a context at 12:07 on Sep. 1, 2022 “SERVICE: 20% OFF APPLIED/ITEM: CHEESEBURGER/USER: USER A” is further stored. This context further includes “ITEM: CHEESEBURGER” and “USER: USER A” as compared with the context at 12:06 on Sep. 1, 2022.

FIG. 17 shows a conversation following the flow in FIG. 16 between the chat service and user 150B (which will also be referred to as “user B” below) in FIG. 15.

Referring to FIG. 17, in response to the message from the chatbot, user terminal 100B outputs a message “I WANT TO ORDER” to the chat service. As information processing server 300 obtains this message, it searches context database 500 for a context associated with the thread shown in FIG. 17. Then, information processing server 300 transmits the message from user terminal 100B, the context obtained as a result of search, and information that identifies the user (user B) of user terminal 100B to order management server 410.

Order management server 410 interprets the message transmitted from information processing server 300 to generate a response “WHAT DO YOU WANT?” to the message. The context transmitted from information processing server 300 can be used for interpretation.

Order management server 410 transmits the generated response to information processing server 300 together with the context of the message. The context of the message includes the context transmitted from information processing server 300 together with the message and/or the context generated in interpretation of the message.

Information processing server 300 transmits the response from order management server 410 to communication server 200. Communication server 200 outputs the response transmitted from information processing server 300 as a reply to user 150B.

Information processing server 300 further has the context transmitted from order management server 410 stored in context database 500.

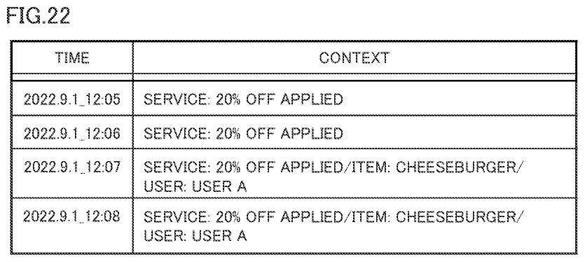

FIG. 22 is a diagram showing yet another example of information stored in context database 500. In FIG. 22, as compared with FIG. 21, a context at 12:08 on Sep. 1, 2022 is further stored.

Referring back to FIG. 17, in response to the message from the chatbot, user terminal 100B outputs a message “I WANT FRENCH FRIES” to the chat service. As information processing server 300 obtains this message, it searches context database 500 for a context associated with the thread shown in FIG. 17. In an example where a plurality of contexts are associated with the thread, information processing server 300 may search for only the latest context. Then, information processing server 300 transmits the message from user terminal 100B, the context obtained as a result of search, and information that identifies the user (user B) of user terminal 100B to order management server 410.

Order management server 410 interprets the message transmitted from information processing server 300 to generate a response “CAN I GET YOU ANYTHING ELSE?” to the message and the order information. The context transmitted from information processing server 300 can be used for interpretation. The order information is generated as a result of interpretation of the message and includes, for example, contents shown in screen OD31 in FIG. 15.

Order management server 410 transmits the generated response “CAN I GET YOU ANYTHING ELSE?” and the order information and the context of the message “I WANT FRENCH FRIES” received from information processing server 300 to information processing server 300. The context of the message “I WANT FRENCH FRIES” includes the context transmitted from information processing server 300 together with the message and/or the context generated in interpretation of the message. When the context “ITEM: FRENCH FRIES” is generated in interpretation of the message “I WANT FRENCH FRIES,” the context of the message may include “SERVICE: 20% OFF APPLIED,” “ITEM: FRENCH FRIES,” and “USER: USER B.”

Information processing server 300 transmits the response and the order information transmitted from order management server 410 to communication server 200, and communication server 200 outputs the response and the order information to the chat service. Information processing server 300 has the context transmitted from order management server 410 stored in context database 500.

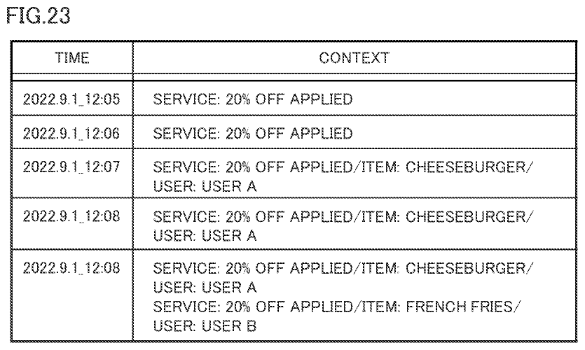

FIG. 23 is a diagram showing yet another example of information stored in context database 500. In FIG. 23, as compared with FIG. 22, a context at 12:09 on Sep. 1, 2022 is further stored. This context further includes “SERVICE: 20% OFF APPLIED/ITEM: FRENCH FRIES/USER: USER B” as compared with the context at 12:08 on Sep. 1, 2022.

In the examples described above with reference to FIGS. 16 to 23, the thread represents an exemplary “entity”. Each of user terminal 100A (user 150A) and user terminal 100B (user 150B) represents an exemplary “unit”. More specifically, user 150A represents an exemplary first unit and user 150B represents an exemplary second unit. In one implementation, each of user 150A and user 150B is identified by use of account names different from each other in the chat service.

In this example, in interpretation of a message in a certain thread, not only the context of the message from the user but also the context of the message from the chatbot can also be used. Though pieces of order information from a plurality of users are generated as being distinguished from one another in the thread, messages from the plurality of users are interpreted with the use of the context common in the thread. In other words, order management server 410 associates the order information generated based on the message received from user 150A with user 150A and associates the order information generated based on the message received from user 150B with user 150B.

[3. Second Specific Example of Generation of Order Information]

(Interaction)

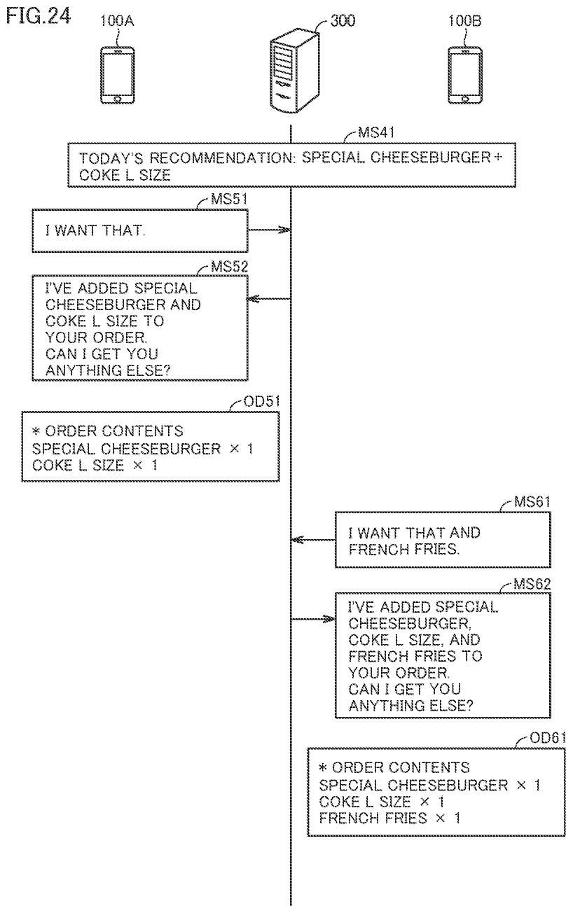

FIG. 24 is a diagram showing yet another exemplary interaction in message processing system 2. In the example in FIG. 24, as in the example in FIG. 15, user 150A and user 150B input a message in a certain thread in the chat service. In message processing system 2, as the messages from user 150A and user 150B are interpreted with the use of the context common in the thread, order information of each of user 150A and user 150B is generated.

Referring to FIG. 24, the chatbot (information processing server 300) outputs a message “TODAY'S RECOMMENDATION: SPECIAL CHEESEBURGER+COKE L SIZE” as a message MS41. In one implementation, this message is generated by order management server 410 and transmitted to communication server 200 through information processing server 300. Communication server 200 outputs the message transmitted from order management server 410 to the chat service as the message from the chatbot.

In response, user terminal 100A (user 150A) inputs a message “I WANT THAT” to the chat service as shown with a message MS51.

In response, the chatbot outputs a message “I'VE ADDED SPECIAL CHEESEBURGER AND COKE L SIZE TO YOUR ORDER. CAN I GET YOU ANYTHING ELSE?” as shown with a message MS52.

The chatbot further outputs order information generated based on message MS51. The order information includes “SPECIAL CHEESE BURGER×1” and “COKE L SIZE×1” as shown with a screen OD51. This order information represents one item “SPECIAL CHEESE BURGER” and one item “COKE L SIZE.” These items are based on the context in the message in the past in this thread.

More specifically, in this thread, message MS41 includes “SPECIAL CHEESE BURGER” and “COKE L SIZE.” They each represent an item. The context of message MS41 thus includes “ITEM: SPECIAL CHEESE BURGER” and “ITEM: COKE L SIZE.” Message MS51 is interpreted with this context. Order management server 410 thus recognizes the pronoun “THAT” in message MS51 as the item “SPECIAL CHEESE BURGER” and “COKE L SIZE” included in the context.

User terminal 100B (user 150B) inputs a message “I WANT THAT AND FRENCH FRIES” to the chat service as shown with a message MS61.

In response, the chatbot outputs a message “I'VE ADDED SPECIAL CHEESEBURGER, COKE L SIZE, AND FRENCH FRIES TO YOUR ORDER. CAN I GET YOU ANYTHING ELSE?” as shown with a message MS62.

The chatbot further outputs order information generated based on message MS61. The order information includes “SPECIAL CHEESEBURGER×1,” “COKE L SIZE×1,” and “FRENCH FRIES×1” as shown with a screen OD61. This order information represents one item “SPECIAL CHEESE BURGER” and one item “COKE L SIZE.” These items are based on the context of the message in the past in this thread. The order information further represents one item “FRENCH FRIES.” This item is based on message MS61.

More specifically, order management server 410 recognizes the pronoun “THAT” in message MS61 as the items “SPECIAL CHEESE BURGER” and “COKE L SIZE” based on the context of message MS41, similarly to the pronoun “THAT” in message MS51. Then, order management server 410 further recognizes the item “FRENCH FRIES” based on “AND FRENCH FRIES” included in message MS61.

(Flow of Information)

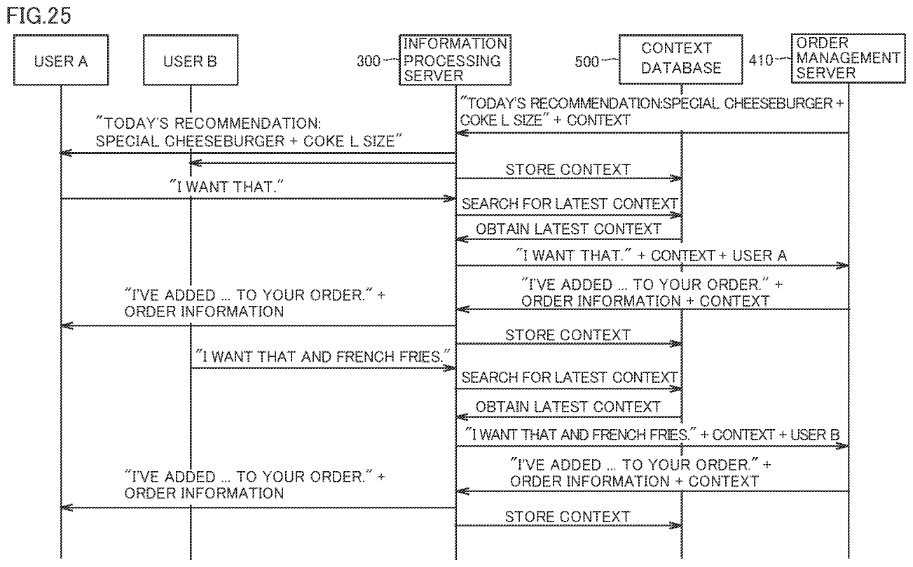

FIG. 25 is a diagram schematically showing a flow of information in generation of order information shown in FIG. 24.

Referring to FIG. 25, order management server 410 transmits the message “TODAY'S RECOMMENDATION: SPECIAL CHEESEBURGER+COKE L SIZE” and the context of this message to information processing server 300. Information processing server 300 transmits the message from order management server 410 to communication server 200 as the message from the chatbot. Communication server 200 outputs this message in the chat service.

Information processing server 300 has the context stored in context database 500.

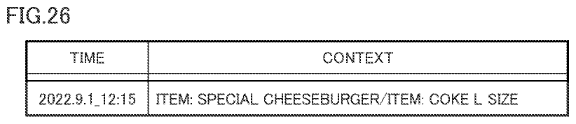

FIG. 26 is a diagram showing an example of information stored in context database 500. In the example in FIG. 26, the context “ITEM: SPECIAL CHEESEBURGER/ITEM: COKE L SIZE” is stored together with time (12:15 on Sep. 1, 2022).

Referring back to FIG. 25, in response to the message from the chatbot, user terminal 100A outputs the message “I WANT THAT” to the chat service. As information processing server 300 obtains this message, it searches context database 500 for a context associated with the thread shown in FIG. 25. Then, information processing server 300 transmits the message from user terminal 100A, the context obtained as a result of search, and information that identifies the user (user A) of user terminal 100A to order management server 410.

Order management server 410 interprets the message transmitted from information processing server 300 to generate a response “I'VE ADDED SPECIAL CHEESEBURGER AND COKE L SIZE TO YOUR ORDER. CAN I GET YOU ANYTHING ELSE?” to the message and order information. The context transmitted from information processing server 300 can be used for interpretation.

Order management server 410 transmits the generated response and order information to information processing server 300 together with the context of the message. The context of the message includes the context transmitted from information processing server 300 together with the message and/or the context generated in interpretation of the message.

Information processing server 300 transmits the response and the order information from order management server 410 to communication server 200. Communication server 200 outputs the response and the order information transmitted from information processing server 300 as a reply to user 150A.

Information processing server 300 further has the context transmitted from order management server 410 stored in context database 500.

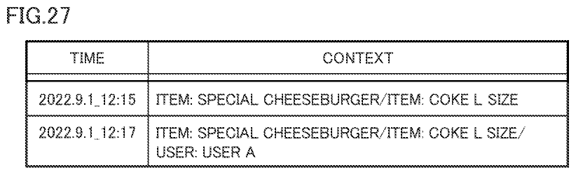

FIG. 27 is a diagram showing yet another example of information stored in context database 500. In FIG. 27, a context at 12:17 on Sep. 1, 2022 is further stored. This context further includes “USER: USER A” as compared with the context at 12:15 on the same day. This context means that order information of user A includes the item “SPECIAL CHEESE BURGER” and “COKE L SIZE.”

Referring back to FIG. 25, in response to the message from the chatbot, user terminal 100B outputs a message “I WANT THAT AND FRENCH FRIES” to the chat service. As information processing server 300 obtains this message, it searches context database 500 for a context associated with the thread shown in FIG. 25. Then, information processing server 300 transmits the message from user terminal 100B, the context obtained as a result of search, and information that identifies the user (user B) of user terminal 100B to order management server 410.

Order management server 410 interprets the message transmitted from information processing server 300 to generate a response “I'VE ADDED SPECIAL CHEESEBURGER, COKE L SIZE, AND FRENCH FRIES TO YOUR ORDER. CAN I GET YOU ANYTHING ELSE?” to the message and order information. The context transmitted from information processing server 300 can be used for interpretation.

Order management server 410 transmits the generated response to information processing server 300 together with the context of the message. The context of the message includes the context transmitted from information processing server 300 together with the message and/or the context generated in interpretation of the message.

Information processing server 300 transmits the response from order management server 410 to communication server 200. Communication server 200 outputs the response transmitted from information processing server 300 as a reply to user 150B.

Information processing server 300 further has the context transmitted from order management server 410 stored in context database 500.

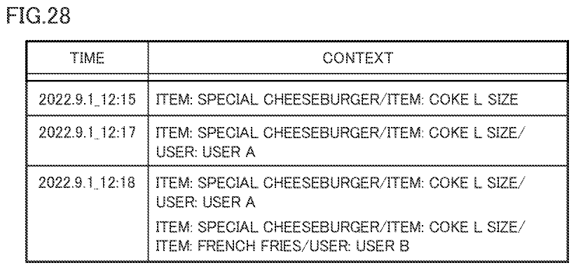

FIG. 28 is a diagram showing yet another example of information stored in context database 500. In FIG. 28, as compared with FIG. 27, a context at 12:18 on Sep. 1, 2022 is further stored. This context includes “ITEM: SPECIAL CHEESEBURGER/ITEM: COKE L SIZE/ITEM: FRENCH FRIES/USER: USER B” as compared with the context at 12:17 on the same day. This context means that the order information of user A includes the items “SPECIAL CHEESE BURGER” and “COKE L SIZE” and the order information of user B includes the items “SPECIAL CHEESE BURGER,” “COKE L SIZE,” and “FRENCH FRIES.”

In the example described above with reference to FIGS. 24 to 28, when order management server 410 interprets the message from the user with the use of the context including information identifying an item, it recognizes the pronoun in the message as the item included in the context.

[4. Flow of Processing]

A flow of processing performed by information processing server 300 and order management server 410 in the second embodiment may be similar to the flow of processing performed by information processing server 300 and conversation server 400 described with reference to FIG. 13.

In the second embodiment, information processing server 300 may have not only the context of the message from the user but also the context of the message from the chatbot stored in context database 500.

In the second embodiment, order management server 410 generates order information in addition to the response (or as a part of the response). Information processing server 300 transmits the response and the order information (or the response including the order information) transmitted from order management server 410 to communication server 200. Thus, in the chat service, the response and the order information (or the response including the order information) are provided to the user.

### MODIFICATION

Contents of the service described in each of the first and second embodiments are merely by way of example of a manner of use of the message processing system. The service to which the message processing method in the present disclosure is applied is not limited to the above. The message processing method in the present disclosure may be applied to a system of another type such as a social networking service (SNS). The “thread” represents an exemplary entity which is a range where a context is shared. So long as a range can be distinguished as the range where the context is shared, other examples of a unit in the entity may be one talk room in the SNS or one user account in a virtual assistant service.

It should be understood that each embodiment disclosed herein is illustrative and non-restrictive in every respect. The scope of the present invention is defined by the terms of the claims rather than the description above and is intended to include any modifications within the scope and meaning equivalent to the terms of the claims. The invention described in the embodiment and each modification is intended to be carried out alone or in combination as much as possible.

### REFERENCE SIGNS LIST

1, 2 message processing system; 100, 100A, 100B user terminal; 150, 150A, 150B user; 200 communication server; 300 information processing server; 400 conversation server; 410 order management server; 500 context database; MS11, 21 to 24, 31 to 34, 41, 51, 52, 61, 62 message; OD21, 31, 51, 61 screen

1. A message processing method comprising:
obtaining, by an information processing apparatus, a first message from a first entity;
storing, by the information processing apparatus, a context of the first message in a storage device in association with the first entity;
obtaining, by the information processing apparatus, a second message from the first entity; and
providing, by the information processing apparatus, the second message to an interpretation server that interprets a message, together with the context of the first message.

2. The message processing method according to claim 1, further comprising searching, by the information processing apparatus, the storage device for a context associated with the first entity in response to obtainment of the second message.

3. The message processing method according to claim 1 or 2, further comprising:
providing, by the information processing apparatus, the first message to the interpretation server; and
obtaining, by the information processing apparatus, the context of the first message from the interpretation server.

4. The message processing method according to claim 1 or 2, wherein
the context of the first message is stored in the storage device together with an element representing recency of the context of the first message, and
the message processing method further comprises:
storing, by the information processing apparatus, a context of the second message and recency of the context of the second message in the storage device in association with the first entity;
obtaining, by the information processing apparatus, a third message from the first entity;
searching, by the information processing apparatus, the storage device for a latest context associated with the first entity in response to obtainment of the third message; and
providing, by the information processing apparatus, the third message to the interpretation server together with the latest context.

5. The message processing method according to claim 2, comprising:
obtaining, by the information processing apparatus, a third message from a second entity;
storing, by the information processing apparatus, a context of the third message in the storage device in association with the second entity;
obtaining, by the information processing apparatus, a fourth message from the second entity; and
providing, by the information processing apparatus, the fourth message to the interpretation server together with the context of the third message.

6. The message processing method according to claim 2, wherein
the first message is obtained from a first unit in the first entity; and
the second message is obtained from a second unit in the first entity.

7. The message processing method according to claim 6, wherein
the interpretation server interprets the first message and associates a result of interpretation of the first message with the first unit, and
the interpretation server interprets the second message and associates a result of interpretation of the second message with the second unit.

8. The message processing method according to claim 6, wherein
the context of the first message includes information that identifies a target item, and
interpreting the second message includes recognizing a pronoun in the second message as the target item.

9. An information processing apparatus comprising:
at least one processor; and
a memory where a program to be executed by the at least one processor is stored, wherein
the program, by being executed by the at least one processor, causes the at least one processor to perform a message processing method comprising the steps of:
obtaining, by an information processing apparatus, a first message from a first entity;
storing, by the information processing apparatus, a context of the first message in a storage device in association with the first entity;
obtaining, by the information processing apparatus, a second message from the first entity; and
providing, by the information processing apparatus, the second message to an interpretation server that interprets a message, together with the context of the first message.

10. A program, by being executed by at least one processor, causing the at least one processor to perform the message processing method according to claim 9.
